(19) United States
(12) Patent Application Publication
(10) Pub. No.: US 2026/0111296 A1
(43) Pub. Date: Apr. 23, 2026

(54) SYSTEM

(71) Applicant: SoftBank Group Corp., Tokyo (JP)

(72) Inventor: Hiromichi KAGEYAMA, Tokyo (JP)

(21) Appl. No.: 19/354,245

(22) Filed: Oct. 9, 2025

(30) Foreign Application Priority Data
Oct. 18, 2024 (JP) 2024-183955

(51) Int. Cl. G06F 11/00; G06F 21/64

(52) U.S. Cl. CPC G06F 11/008; G06F 21/645

(57) ABSTRACT

The system according to the embodiment includes a reception unit, an analysis unit, a request unit, a check unit, and an accumulation unit. The reception unit receives requests from a requester. The analysis unit analyzes the requests received by the reception unit. The request unit sends requests to experts identified by the analysis unit. The check unit allows the experts who received the requests from the request unit to perform checks. The accumulation unit accumulates the results obtained by the check unit.

### CROSS-REFERENCE TO RELATED APPLICATION

The present application claims priority to and incorporates by reference the entire contents of Japanese Patent Application No. 2024-183955 filed in Japan on October 18, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is not possible to completely prevent the generation of incorrect information by generative AI, making it difficult to ensure the reliability of the generated products.

### SUMMARY OF THE INVENTION

The system according to the embodiment includes a reception unit, an analysis unit, a request unit, a check unit, and an accumulation unit. The reception unit receives requests from a requester. The analysis unit analyzes the requests received by the reception unit. The request unit sends requests to experts identified by the analysis unit. The check unit allows the experts who received the requests from the request unit to perform checks. The accumulation unit accumulates the results obtained by the check unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as "processor") may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, "A and/or B" means "at least one of A and B." In other words, "A and/or B" means it may be only A, only B, or a combination of A and B. Moreover, when expressing three or more items connected by "and/or," the same concept as "A and/or B" applies.

### First Embodiment

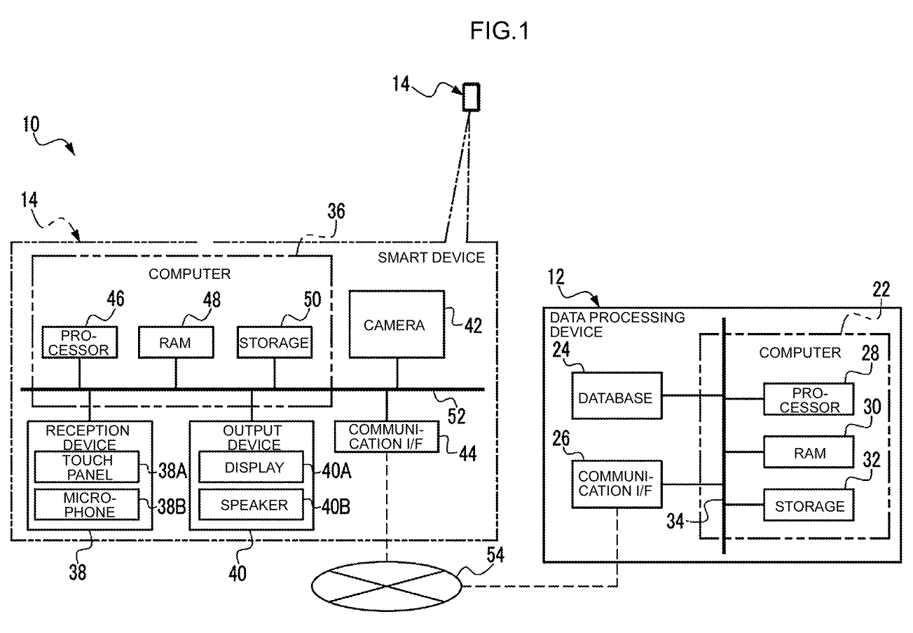

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

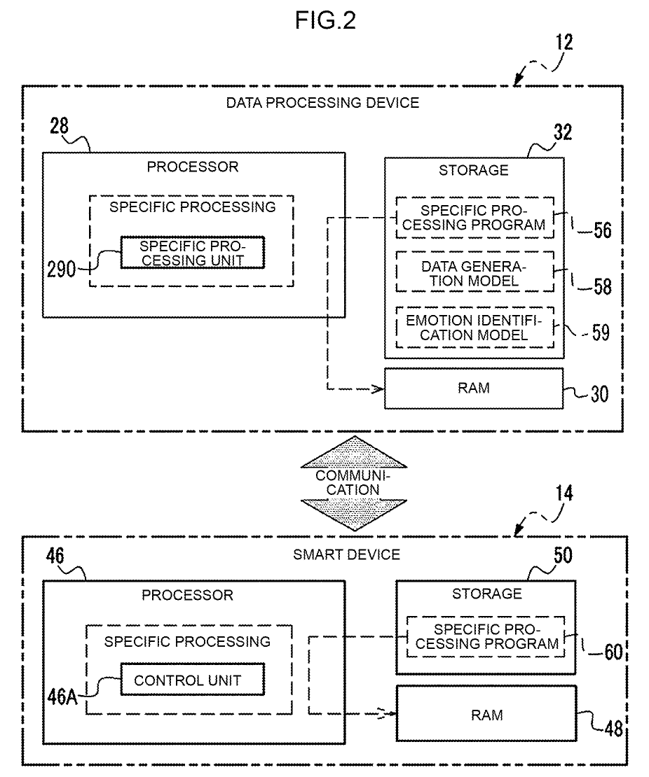

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### [Example 1 of Embodiment]

The hallucination countermeasure system according to the embodiment of the present invention is a sharing economy service for addressing the "hallucination" problem, in which generative AI generates incorrect information. This system is based on the premise that, as generative AI comes to perform advanced reasoning at the doctoral level, only experts of the same level can judge its accuracy. The number of users utilizing generative AI for professional purposes such as research and development or creative work is rapidly increasing, and ensuring the reliability of generative AI outputs is an urgent issue. This system matches "requesters who require advanced hallucination checks" with "experts in various fields registered in the system," and the experts check the requested generated products to ensure their reliability. In this way, both "hallucination countermeasures" and "utilization of expert resources" are achieved. Specifically, the system consists of the following steps. First, the requester specifies the range of portions in the output result of the generative AI suspected of hallucination and submits a request for content verification to the system, specifying the reward cap and deadline as well. Next, the system analyzes the request from the requester, identifies the specialized field and required skill level necessary for the check, and sends requests simultaneously to all experts matching the case. The experts confirm the request conditions and accept the request. The experts then use their expertise to eliminate hallucinations. Furthermore, among the verification results by the checker, those that received high evaluations from the requester are accumulated in a search-extended generation database and are associated as reference information when similar requests are made in the future. This checker support database function improves the efficiency of future checker operations and enhances the reliability of checks. Through this mechanism, the reliability of generative AI outputs is greatly improved, and expert resources can be effectively utilized. For example, in research, technology development, due diligence, and business planning, the accuracy of generative AI outputs is particularly important. By using this system, the reliability of AI-generated results is greatly improved. In addition, for creators such as screenwriters, science fiction writers, historical writers, and manga artists who require intricate technical or historical verification, this system is also highly effective. By ensuring the accuracy of AI-generated results, the quality of creative activities is greatly enhanced. Thus, the hallucination countermeasure system can greatly improve the reliability of generative AI outputs and effectively utilize expert resources.

The hallucination countermeasure system according to the embodiment includes a reception unit, an analysis unit, a request unit, a check unit, and an accumulation unit. The reception unit receives requests from a requester. The requests from the requester may include, for example, document format, oral requests, emails, etc., but are not limited to these examples. The reception unit can, for example, allow the requester to specify a range of portions in the output result of a generative AI suspected of hallucination and submit a request for content verification. The analysis unit analyzes the requests received by the reception unit. The analysis unit can analyze the requests using methods such as text analysis, data mining, and statistical analysis. The analysis unit analyzes the requests and identifies the specialized field and required skill level necessary for the check. The request unit sends requests to experts identified by the analysis unit. The request unit can, for example, send requests simultaneously to all experts matching the case. The request unit can send requests using mass email or notification systems. The check unit allows the experts who received the requests from the request unit to perform checks. The check unit can perform checks using methods such as review, verification, and testing. The check unit allows the experts to confirm the request conditions and accept the request to perform the check. The accumulation unit accumulates the results obtained by the check unit. The accumulation unit can, for example, store the results in a database or accumulate them in report format. The accumulation unit accumulates, in a search-extended generation database, those verification results by the checker that received high evaluations from the requester. In this way, the hallucination countermeasure system according to the embodiment can efficiently receive, analyze, request, check, and accumulate the results of requests from requesters. Some or all of the above-described processing in the reception unit, analysis unit, request unit, check unit, and accumulation unit may be performed using AI or may be performed without using AI. For example, the reception unit can input requests from the requester into AI and have the AI perform the reception. The analysis unit can input requests into AI and have the AI perform the analysis. The request unit can input requests into AI and have the AI perform the requests to experts. The check unit can input requests into AI and have the AI perform the checks. The accumulation unit can input check results into AI and have the AI perform the accumulation of results.

The reception unit receives requests from a requester. The requests from the requester may include, for example, document format, oral requests, emails, etc., but are not limited to these examples. The reception unit can, for example, allow the requester to specify a range of portions in the output result of a generative AI suspected of hallucination and submit a request for content verification. Specifically, the reception unit is equipped with an interface for receiving information provided by the requester in various formats. For example, when receiving requests through a web portal, the requester can enter the necessary information in a dedicated form and highlight portions suspected of hallucination. In the case of oral requests, the content of the request can be converted to text using speech recognition technology and incorporated into the system. For email requests, the system has a mechanism to automatically analyze emails sent to a dedicated email address and extract the request content. Furthermore, the reception unit performs initial filtering of the request content, automatically detecting clearly inappropriate requests or incomplete information and prompting the requester to make corrections. In this way, the reception unit can efficiently and accurately receive requests and smoothly hand them over to the next processing step.

The analysis unit analyzes the requests received by the reception unit. The analysis unit can analyze the requests using methods such as text analysis, data mining, and statistical analysis. Specifically, the analysis unit utilizes natural language processing technology to analyze the request content in detail and identify portions suspected of hallucination. For example, in text analysis, topic modeling and sentiment analysis can be performed to understand the context of the request content and extract suspicious portions. In data mining, past request data and similar cases are referenced to find patterns and trends. In statistical analysis, statistical methods are used to evaluate the reliability and consistency of the request content. Furthermore, the analysis unit identifies the specialized field and required skill level necessary for the check based on the request content. For example, in the case of a request related to hallucination in the medical field, experts with medical expertise or skills in medical data analysis are required. In this way, the analysis unit can accurately understand the request content and prepare for making requests to appropriate experts.

The request unit sends requests to experts identified by the analysis unit. The request unit can, for example, send requests simultaneously to all experts matching the case. Specifically, the request unit refers to an expert database and selects the most suitable experts for the request content. The expert database contains detailed records of each expert's skill set, past achievements, evaluations, etc., and the optimal experts are identified based on this information. The request unit can send requests using mass email or notification systems. For example, after matching the request content with the experts' skills, the selected experts are sent request emails simultaneously to prompt a prompt response. In addition, notification systems can be used to send real-time notifications to the experts' smartphones or computers. The request unit also has a function to manage the progress of requests and track responses from experts. In this way, the request unit can efficiently send requests to experts and promote prompt responses.

The check unit allows the experts who received the requests from the request unit to perform checks. The check unit can perform checks using methods such as review, verification, and testing. Specifically, the check unit manages the process in which the expert confirms the request conditions, accepts the request, and performs the check. The expert reviews the output result of the generative AI in detail based on the request content and checks for the presence or absence of hallucination. In the review, literature and databases are referenced to verify whether the output of the generative AI is accurate. In verification, actual data and experiments are used to confirm whether the output of the generative AI matches reality. In testing, the output of the generative AI is reproduced to confirm whether similar results can be obtained. The check unit records the results of the checks performed by the experts and prepares reports to report to the requester. Furthermore, the check unit collects feedback from experts and can use it to improve the system. In this way, the check unit can perform accurate checks on the request content and provide highly reliable results to the requester.

The accumulation unit accumulates the results obtained by the check unit. The accumulation unit can, for example, store the results in a database or accumulate them in report format. Specifically, the accumulation unit centrally manages the results provided by the check unit so that they can be used for future reference and analysis. The database stores detailed information on each request, check results, expert feedback, etc. This enables trend analysis and pattern recognition based on past request data. Furthermore, the accumulation unit accumulates, in a search-extended generation database, those verification results by the checker that received high evaluations from the requester. In this way, the system can respond to future requests with higher accuracy based on highly evaluated past results. The accumulation unit also takes into account data security and privacy protection, and the stored data is encrypted and protected from unauthorized access. In this way, the accumulation unit can achieve highly reliable data management and improve the overall performance and reliability of the system.

The reception unit can allow the requester to specify a range of portions in the output result of a generative AI suspected of hallucination and submit a request for content verification. The reception unit, for example, allows the requester to specify a range of portions in the output result of a generative AI suspected of hallucination and submit a request for content verification. The reception unit can also allow the requester to specify a reward cap and deadline when submitting a request for content verification. In this way, the requester can specify a range of portions suspected of hallucination and submit a request for content verification. Portions suspected of hallucination may include, for example, information that differs from facts or incorrect inferences, but are not limited to these examples. Some or all of the above-described processing in the reception unit may be performed using AI or may be performed without using AI. For example, the reception unit can input requests from the requester into AI and have the AI perform the reception.

The analysis unit can analyze the request from the requester and identify the specialized field and required skill level necessary for the check. The analysis unit, for example, analyzes the request from the requester using methods such as text analysis, data mining, and statistical analysis. The analysis unit analyzes the request and identifies the specialized field and required skill level necessary for the check. In this way, the analysis unit can analyze the request from the requester and identify the specialized field and required skill level necessary for the check. The required specialized fields may include, for example, medicine, law, technology, etc., but are not limited to these examples. The required skill levels may include, for example, beginner, intermediate, advanced, etc., but are not limited to these examples. Some or all of the above-described processing in the analysis unit may be performed using AI or may be performed without using AI. For example, the analysis unit can input requests into AI and have the AI perform the analysis.

The request unit can send requests simultaneously to all experts matching the case. The request unit, for example, sends requests simultaneously to all experts matching the case. The request unit can send requests using mass email or notification systems. In this way, the request unit can send requests simultaneously to all experts matching the case. Methods for sending requests simultaneously may include, for example, mass email or notification systems, but are not limited to these examples. Some or all of the above-described processing in the request unit may be performed using AI or may be performed without using AI. For example, the request unit can input requests into AI and have the AI perform the requests to experts.

The check unit can allow the expert to confirm the request conditions and accept the request to perform the check. The check unit, for example, allows the expert to confirm the request conditions and accept the request to perform the check. The check unit can perform checks using methods such as review, verification, and testing. In this way, the expert can confirm the request conditions and accept the request to perform the check. The request conditions may include, for example, delivery date, quality standards, reward, etc., but are not limited to these examples. Some or all of the above-described processing in the check unit may be performed using AI or may be performed without using AI. For example, the check unit can input requests into AI and have the AI perform the checks.

The accumulation unit can accumulate, in a search-extended generation database, those verification results by the checker that received high evaluations from the requester. The accumulation unit, for example, accumulates, in a search-extended generation database, those verification results by the checker that received high evaluations from the requester. In this way, the accumulation unit can accumulate, in a search-extended generation database, those results that received high evaluations from the requester. Results that received high evaluations may include, for example, feedback from the requester or evaluation scores, but are not limited to these examples. Some or all of the above-described processing in the accumulation unit may be performed using AI or may be performed without using AI. For example, the accumulation unit can input check results into AI and have the AI perform the accumulation of results.

The reception unit can analyze the requester's past request history and select an optimal reception method. The reception unit, for example, preferentially proposes reception methods that the requester has frequently used in the past. The reception unit can also select the most efficient reception method based on the requester's past request history. The reception unit can also propose the optimal reception method for a specific time period based on the requester's past request history. In this way, the reception unit can analyze the requester's past request history and select an optimal reception method. The optimal reception methods may include, for example, online forms, telephone reception, etc., but are not limited to these examples. Some or all of the above-described processing in the reception unit may be performed using AI or may be performed without using AI. For example, the reception unit can input the requester's past request history into AI and have the AI select the optimal reception method.

The reception unit can perform filtering based on the requester's current projects and areas of interest at the time of receiving the request content. The reception unit, for example, preferentially receives request content related to the requester's ongoing projects. The reception unit can also filter highly relevant request content based on the requester's areas of interest. The reception unit can also propose optimal request content according to the progress of the requester's current projects. In this way, the reception unit can perform filtering based on the requester's current projects and areas of interest. The current projects and areas of interest may include, for example, project management tools, survey results, etc., but are not limited to these examples. Some or all of the above-described processing in the reception unit may be performed using AI or may be performed without using AI. For example, the reception unit can input data on the requester's current projects and areas of interest into AI and have the AI perform the filtering.

The reception unit can prioritize the reception of highly relevant requests by considering the requester's geographic location at the time of receiving the request content. The reception unit, for example, preferentially receives request content related to a specific region when the requester is in that region. The reception unit can also propose optimal request content based on the requester's current location. The reception unit can also filter highly relevant request content based on the requester's geographic location information. In this way, the reception unit can prioritize the reception of highly relevant requests by considering the requester's geographic location. Geographic location information may include, for example, GPS data, address information, etc., but are not limited to these examples. Some or all of the above-described processing in the reception unit may be performed using AI or may be performed without using AI. For example, the reception unit can input the requester's geographic location information into AI and have the AI perform the filtering.

The reception unit can analyze the requester's social media activity at the time of receiving the request content and receive related requests. The reception unit, for example, preferentially receives request content related to areas of interest based on the requester's social media activity. The reception unit can also propose optimal request content based on the requester's social media activity. The reception unit can also analyze the requester's social media activity and filter highly relevant request content. In this way, the reception unit can analyze the requester's social media activity and receive related requests. Social media activity may include, for example, post content, number of followers, etc., but are not limited to these examples. Some or all of the above-described processing in the reception unit may be performed using AI or may be performed without using AI. For example, the reception unit can input the requester's social media activity data into AI and have the AI perform the analysis.

The analysis unit can adjust the level of detail of the analysis based on the importance of the request content during analysis. The analysis unit, for example, performs detailed analysis for highly important request content. The analysis unit can also perform simplified analysis for less important request content. The analysis unit can also dynamically adjust the level of detail of the analysis according to the importance of the request content. In this way, the analysis unit can adjust the level of detail of the analysis based on the importance of the request content. The importance of the request content may include, for example, business impact, urgency, etc., but are not limited to these examples. Some or all of the above-described processing in the analysis unit may be performed using AI or may be performed without using AI. For example, the analysis unit can input importance data of the request content into AI and have the AI adjust the level of detail of the analysis.

The analysis unit can apply different analysis algorithms according to the category of the request content during analysis. The analysis unit, for example, applies specialized analysis algorithms to technical request content. The analysis unit can also apply creative analysis algorithms to creative request content. The analysis unit can also select the optimal analysis algorithm according to the category of the request content. In this way, the analysis unit can apply different analysis algorithms according to the category of the request content. The categories of the request content may include, for example, technology, marketing, legal affairs, etc., but are not limited to these examples. Some or all of the above-described processing in the analysis unit may be performed using AI or may be performed without using AI. For example, the analysis unit can input category data of the request content into AI and have the AI apply the analysis algorithm.

The analysis unit can determine the priority of analysis based on the submission timing of the request content during analysis. The analysis unit, for example, gives top priority to urgent request content. The analysis unit can also prioritize analysis for request content with a near deadline. The analysis unit can also dynamically adjust the priority of analysis according to the submission timing of the request content. In this way, the analysis unit can determine the priority of analysis based on the submission timing of the request content. The submission timing of the request content may include, for example, submission date, deadline, etc., but are not limited to these examples. Some or all of the above-described processing in the analysis unit may be performed using AI or may be performed without using AI. For example, the analysis unit can input submission timing data of the request content into AI and have the AI determine the priority.

The analysis unit can adjust the order of analysis based on the relevance of the request content during analysis. The analysis unit, for example, gives priority to analysis when the request content is related to other request content. The analysis unit can also determine the optimal analysis order based on the relevance of the request content. The analysis unit can also dynamically adjust the order of analysis by considering the relevance of the request content. In this way, the analysis unit can adjust the order of analysis based on the relevance of the request content. The relevance of the request content may include, for example, degree of theme match, past relevance, etc., but are not limited to these examples. Some or all of the above-described processing in the analysis unit may be performed using AI or may be performed without using AI. For example, the analysis unit can input relevance data of the request content into AI and have the AI adjust the order.

The request unit can adjust the level of detail of the request based on the importance of the expert at the time of requesting. The request unit, for example, provides detailed request content to highly important experts. The request unit can also provide simplified request content to less important experts. The request unit can also dynamically adjust the level of detail of the request according to the importance of the expert. In this way, the request unit can adjust the level of detail of the request based on the importance of the expert. The importance of the expert may include, for example, years of experience, past achievements, etc., but are not limited to these examples. Some or all of the above-described processing in the request unit may be performed using AI or may be performed without using AI. For example, the request unit can input importance data of the expert into AI and have the AI adjust the level of detail.

The request unit can apply different request algorithms according to the category of the expert at the time of requesting. The request unit, for example, applies specialized request algorithms to technical experts. The request unit can also apply creative request algorithms to creative experts. The request unit can also select the optimal request algorithm according to the category of the expert. In this way, the request unit can apply different request algorithms according to the category of the expert. The categories of the expert may include, for example, medicine, law, technology, etc., but are not limited to these examples. Some or all of the above-described processing in the request unit may be performed using AI or may be performed without using AI. For example, the request unit can input category data of the expert into AI and have the AI apply the request algorithm.

The request unit can determine the priority of the request based on the submission timing of the expert at the time of requesting. The request unit, for example, gives top priority to urgent request content. The request unit can also prioritize requests for request content with a near deadline. The request unit can also dynamically adjust the priority of the request according to the submission timing of the expert. In this way, the request unit can determine the priority of the request based on the submission timing of the expert. The submission timing of the expert may include, for example, submission date, deadline, etc., but are not limited to these examples. Some or all of the above-described processing in the request unit may be performed using AI or may be performed without using AI. For example, the request unit can input submission timing data of the expert into AI and have the AI determine the priority.

The request unit can adjust the order of the request based on the relevance of the expert at the time of requesting. The request unit, for example, gives priority to requests when the expert is related to other request content. The request unit can also determine the optimal request order based on the relevance of the expert. The request unit can also dynamically adjust the order of the request by considering the relevance of the expert. In this way, the request unit can adjust the order of the request based on the relevance of the expert. The relevance of the expert may include, for example, degree of theme match, past relevance, etc., but are not limited to these examples. Some or all of the above-described processing in the request unit may be performed using AI or may be performed without using AI. For example, the request unit can input relevance data of the expert into AI and have the AI adjust the order.

The check unit can analyze the past history of the request content at the time of checking and select the optimal checking method. The check unit, for example, selects the most efficient checking method based on the past history of the request content. The check unit can also propose the optimal checking method for a specific time period based on the past history of the request content. The check unit can also dynamically adjust the optimal checking method by analyzing the past history of the request content. In this way, the check unit can analyze the past history of the request content and select the optimal checking method. The optimal checking methods may include, for example, past history analysis, algorithm selection, etc., but are not limited to these examples. Some or all of the above-described processing in the check unit may be performed using AI or may be performed without using AI. For example, the check unit can input past history data of the request content into AI and have the AI select the checking method.

The check unit can customize the means of checking based on the current status of the request content at the time of checking. The check unit, for example, selects the optimal checking means according to the current status of the request content. The check unit can also propose specific checking means based on the current status of the request content. The check unit can also dynamically customize the checking means by considering the current status of the request content. In this way, the check unit can customize the means of checking based on the current status of the request content. The current status of the request content may include, for example, progress status, resource status, etc., but are not limited to these examples. Some or all of the above-described processing in the check unit may be performed using AI or may be performed without using AI. For example, the check unit can input current status data of the request content into AI and have the AI customize the means.

The check unit can select the optimal checking method by considering the geographic location information of the request content at the time of checking. The check unit, for example, preferentially processes checking content related to a specific region when the requester is in that region. The check unit can also propose the optimal checking method based on the requester's current location. The check unit can also filter highly relevant checking content based on the requester's geographic location information. In this way, the check unit can select the optimal checking method by considering the geographic location information of the request content. Geographic location information may include, for example, GPS data, address information, etc., but are not limited to these examples. Some or all of the above-described processing in the check unit may be performed using AI or may be performed without using AI. For example, the check unit can input geographic location information of the request content into AI and have the AI select the checking method.

The check unit can analyze the social media activity of the request content at the time of checking and propose means of checking. The check unit, for example, preferentially processes checking content related to areas of interest based on the requester's social media activity. The check unit can also propose the optimal checking means based on the requester's social media activity. The check unit can also analyze the requester's social media activity and filter highly relevant checking content. In this way, the check unit can analyze the social media activity of the request content and propose means of checking. Social media activity may include, for example, post content, number of followers, etc., but are not limited to these examples. Some or all of the above-described processing in the check unit may be performed using AI or may be performed without using AI. For example, the check unit can input social media activity data of the request content into AI and have the AI propose the means.

The accumulation unit can optimize the accumulation algorithm by referring to past accumulation data at the time of accumulation. The accumulation unit, for example, selects the optimal accumulation algorithm based on past accumulation data. The accumulation unit can also propose the optimal accumulation algorithm for a specific time period by referring to past accumulation data. The accumulation unit can also dynamically adjust the optimal accumulation algorithm by analyzing past accumulation data. In this way, the accumulation unit can optimize the accumulation algorithm by referring to past accumulation data. Accumulation algorithms may include, for example, reference to past data, adjustment of algorithms, etc., but are not limited to these examples. Some or all of the above-described processing in the accumulation unit may be performed using AI or may be performed without using AI. For example, the accumulation unit can input past accumulation data into AI and have the AI optimize the algorithm.

The accumulation unit can select accumulation data based on the current status of the request content at the time of accumulation. The accumulation unit, for example, selects the optimal accumulation data according to the current status of the request content. The accumulation unit can also propose specific accumulation data based on the current status of the request content. The accumulation unit can also dynamically select accumulation data by considering the current status of the request content. In this way, the accumulation unit can select accumulation data based on the current status of the request content. The current status of the request content may include, for example, progress status, resource status, etc., but are not limited to these examples. Some or all of the above-described processing in the accumulation unit may be performed using AI or may be performed without using AI. For example, the accumulation unit can input current status data of the request content into AI and have the AI select the data.

The accumulation unit can weight the accumulation data based on the submission timing of the request content at the time of accumulation. The accumulation unit, for example, accumulates with higher weighting for request content with a near deadline. The accumulation unit can also accumulate with normal weighting for request content with a distant deadline. The accumulation unit can also dynamically adjust the weighting of accumulation data according to the submission timing of the request content. In this way, the accumulation unit can weight the accumulation data based on the submission timing of the request content. The submission timing may include, for example, submission date, deadline, etc., but are not limited to these examples. Some or all of the above-described processing in the accumulation unit may be performed using AI or may be performed without using AI. For example, the accumulation unit can input submission timing data of the request content into AI and have the AI perform the weighting.

The accumulation unit can select accumulation data based on the relevance of the request content at the time of accumulation. The accumulation unit, for example, preferentially accumulates when the request content is related to other request content. The accumulation unit can also select the optimal accumulation data based on the relevance of the request content. The accumulation unit can also dynamically select accumulation data by considering the relevance of the request content. In this way, the accumulation unit can select accumulation data based on the relevance of the request content. The relevance of the request content may include, for example, degree of theme match, past relevance, etc., but are not limited to these examples. Some or all of the above-described processing in the accumulation unit may be performed using AI or may be performed without using AI. For example, the accumulation unit can input relevance data of the request content into AI and have the AI select the data.

The accumulation unit can select accumulation data based on the importance of the request content at the time of accumulation. The accumulation unit, for example, preferentially accumulates for highly important request content. The accumulation unit can also perform normal accumulation for less important request content. The accumulation unit can also dynamically adjust the selection of accumulation data according to the importance of the request content. In this way, the accumulation unit can select accumulation data based on the importance of the request content. The importance of the request content may include, for example, business impact, urgency, etc., but are not limited to these examples. Some or all of the above-described processing in the accumulation unit may be performed using AI or may be performed without using AI. For example, the accumulation unit can input importance data of the request content into AI and have the AI select the data.

The system according to the embodiment is not limited to the above-described examples and, for example, various modifications are possible as described below.

The reception unit can analyze the requester's past request history and select an optimal reception method. For example, the reception unit preferentially proposes reception methods that the requester has frequently used in the past. The most efficient reception method can also be selected based on the requester's past request history. The optimal reception method for a specific time period can also be proposed based on the requester's past request history. In this way, the reception unit can analyze the requester's past request history and select an optimal reception method. The optimal reception methods may include, for example, online forms, telephone reception, etc., but are not limited to these examples. Some or all of the above-described processing in the reception unit may be performed using AI or may be performed without using AI. For example, the reception unit can input the requester's past request history into AI and have the AI select the optimal reception method.

The request unit can adjust the level of detail of the request based on the importance of the expert at the time of requesting. For example, the request unit provides detailed request content to highly important experts. The request unit can also provide simplified request content to less important experts. The request unit can also dynamically adjust the level of detail of the request according to the importance of the expert. In this way, the request unit can adjust the level of detail of the request based on the importance of the expert. The importance of the expert may include, for example, years of experience, past achievements, etc., but are not limited to these examples. Some or all of the above-described processing in the request unit may be performed using AI or may be performed without using AI. For example, the request unit can input importance data of the expert into AI and have the AI adjust the level of detail.

The check unit can analyze the past history of the request content at the time of checking and select the optimal checking method. For example, the check unit selects the most efficient checking method based on the past history of the request content. The optimal checking method for a specific time period can also be proposed based on the past history of the request content. The check unit can also dynamically adjust the optimal checking method by analyzing the past history of the request content. In this way, the check unit can analyze the past history of the request content and select the optimal checking method. The optimal checking methods may include, for example, past history analysis, algorithm selection, etc., but are not limited to these examples. Some or all of the above-described processing in the check unit may be performed using AI or may be performed without using AI. For example, the check unit can input past history data of the request content into AI and have the AI select the checking method.

The accumulation unit can optimize the accumulation algorithm by referring to past accumulation data at the time of accumulation. For example, the accumulation unit selects the optimal accumulation algorithm based on past accumulation data. The optimal accumulation algorithm for a specific time period can also be proposed by referring to past accumulation data. The accumulation unit can also dynamically adjust the optimal accumulation algorithm by analyzing past accumulation data. In this way, the accumulation unit can optimize the accumulation algorithm by referring to past accumulation data. Accumulation algorithms may include, for example, reference to past data, adjustment of algorithms, etc., but are not limited to these examples. Some or all of the above-described processing in the accumulation unit may be performed using AI or may be performed without using AI. For example, the accumulation unit can input past accumulation data into AI and have the AI optimize the algorithm.

The accumulation unit can weight the accumulation data based on the submission timing of the request content at the time of accumulation. For example, the accumulation unit accumulates with higher weighting for request content with a near deadline. The accumulation unit can also accumulate with normal weighting for request content with a distant deadline. The accumulation unit can also dynamically adjust the weighting of accumulation data according to the submission timing of the request content. In this way, the accumulation unit can weight the accumulation data based on the submission timing of the request content. The submission timing may include, for example, submission date, deadline, etc., but are not limited to these examples. Some or all of the above-described processing in the accumulation unit may be performed using AI or may be performed without using AI. For example, the accumulation unit can input submission timing data of the request content into AI and have the AI perform the weighting.

The following is a brief description of the processing flow of Example 1 of the Embodiment.

Step 1: The reception unit receives requests from a requester. The requests from the requester may include document format, oral requests, emails, etc. For example, the requester can specify a range of portions in the output result of a generative AI suspected of hallucination and submit a request for content verification.

Step 2: The analysis unit analyzes the requests received by the reception unit. The analysis unit analyzes the requests using methods such as text analysis, data mining, and statistical analysis, and identifies the specialized field and required skill level necessary for the check.

Step 3: The request unit sends requests to experts identified by the analysis unit. The request unit can send requests simultaneously to all experts matching the case and can use mass email or notification systems to send requests.

Step 4: The check unit allows the experts who received the requests from the request unit to perform checks. The check unit performs checks using methods such as review, verification, and testing, and allows the experts to confirm the request conditions and accept the request to perform the check.

Step5: The accumulation unit accumulates the results obtained by the check unit. The accumulation unit stores the results in a database or accumulates them in report format, and accumulates, in a search-extended generation database, those verification results by the checker that received high evaluations from the requester.

### Example 2 of Embodiment

The hallucination countermeasure system according to the embodiment of the present invention is a sharing economy service for addressing the "hallucination" problem, in which generative AI generates incorrect information. This system is based on the premise that, as generative AI comes to perform advanced reasoning at the doctoral level, only experts of the same level can judge its accuracy. The number of users utilizing generative AI for professional purposes such as research and development or creative work is rapidly increasing, and ensuring the reliability of generative AI outputs is an urgent issue. This system matches "requesters who require advanced hallucination checks" with "experts in various fields registered in the system," and the experts check the requested generated products to ensure their reliability. In this way, both "hallucination countermeasures" and "utilization of expert resources" are achieved. Specifically, the system consists of the following steps. First, the requester specifies the range of portions in the output result of the generative AI suspected of hallucination and submits a request for content verification to the system, specifying the reward cap and deadline as well. Next, the system analyzes the request from the requester, identifies the specialized field and required skill level necessary for the check, and sends requests simultaneously to all experts matching the case. The experts confirm the request conditions and accept the request. The experts then use their expertise to eliminate hallucinations. Furthermore, among the verification results by the checker, those that received high evaluations from the requester are accumulated in a search-extended generation database and are associated as reference information when similar requests are made in the future. This checker support database function improves the efficiency of future checker operations and enhances the reliability of checks. Through this mechanism, the reliability of generative AI outputs is greatly improved, and expert resources can be effectively utilized. For example, in research, technology development, due diligence, and business planning, the accuracy of generative AI outputs is particularly important. By using this system, the reliability of AI-generated results is greatly improved. In addition, for creators such as screenwriters, science fiction writers, historical writers, and manga artists who require intricate technical or historical verification, this system is also highly effective. By ensuring the accuracy of AI-generated results, the quality of creative activities is greatly enhanced. Thus, the hallucination countermeasure system can greatly improve the reliability of generative AI outputs and effectively utilize expert resources.

The hallucination countermeasure system according to the embodiment includes a reception unit, an analysis unit, a request unit, a check unit, and an accumulation unit. The reception unit receives requests from a requester. The requests from the requester may include, for example, document format, oral requests, emails, etc., but are not limited to these examples. The reception unit can, for example, allow the requester to specify a range of portions in the output result of a generative AI suspected of hallucination and submit a request for content verification. The analysis unit analyzes the requests received by the reception unit. The analysis unit can analyze the requests using methods such as text analysis, data mining, and statistical analysis. The analysis unit analyzes the requests and identifies the specialized field and required skill level necessary for the check. The request unit sends requests to experts identified by the analysis unit. The request unit can, for example, send requests simultaneously to all experts matching the case. The request unit can send requests using mass email or notification systems. The check unit allows the experts who received the requests from the request unit to perform checks. The check unit can perform checks using methods such as review, verification, and testing. The check unit allows the experts to confirm the request conditions and accept the request to perform the check. The accumulation unit accumulates the results obtained by the check unit. The accumulation unit can, for example, store the results in a database or accumulate them in report format. The accumulation unit accumulates, in a search-extended generation database, those verification results by the checker that received high evaluations from the requester. In this way, the hallucination countermeasure system according to the embodiment can efficiently receive, analyze, request, check, and accumulate the results of requests from requesters. Some or all of the above-described processing in the reception unit, analysis unit, request unit, check unit, and accumulation unit may be performed using AI or may be performed without using AI. For example, the reception unit can input requests from the requester into AI and have the AI perform the reception. The analysis unit can input requests into AI and have the AI perform the analysis. The request unit can input requests into AI and have the AI perform the requests to experts. The check unit can input requests into AI and have the AI perform the checks. The accumulation unit can input check results into AI and have the AI perform the accumulation of results.

The reception unit receives requests from a requester. The requests from the requester may include, for example, document format, oral requests, emails, etc., but are not limited to these examples. The reception unit can, for example, allow the requester to specify a range of portions in the output result of a generative AI suspected of hallucination and submit a request for content verification. Specifically, the reception unit is equipped with an interface for receiving information provided by the requester in various formats. For example, when receiving requests through a web portal, the requester can enter the necessary information in a dedicated form and highlight portions suspected of hallucination. In the case of oral requests, the content of the request can be converted to text using speech recognition technology and incorporated into the system. For email requests, the system has a mechanism to automatically analyze emails sent to a dedicated email address and extract the request content. Furthermore, the reception unit performs initial filtering of the request content, automatically detecting clearly inappropriate requests or incomplete information and prompting the requester to make corrections. In this way, the reception unit can efficiently and accurately receive requests and smoothly hand them over to the next processing step.

The analysis unit analyzes the requests received by the reception unit. The analysis unit can analyze the requests using methods such as text analysis, data mining, and statistical analysis. Specifically, the analysis unit utilizes natural language processing technology to analyze the request content in detail and identify portions suspected of hallucination. For example, in text analysis, topic modeling and sentiment analysis can be performed to understand the context of the request content and extract suspicious portions. In data mining, past request data and similar cases are referenced to find patterns and trends. In statistical analysis, statistical methods are used to evaluate the reliability and consistency of the request content. Furthermore, the analysis unit identifies the specialized field and required skill level necessary for the check based on the request content. For example, in the case of a request related to hallucination in the medical field, experts with medical expertise or skills in medical data analysis are required. In this way, the analysis unit can accurately understand the request content and prepare for making requests to appropriate experts.

The request unit sends requests to experts identified by the analysis unit. The request unit can, for example, send requests simultaneously to all experts matching the case. Specifically, the request unit refers to an expert database and selects the most suitable experts for the request content. The expert database contains detailed records of each expert's skill set, past achievements, evaluations, etc., and the optimal experts are identified based on this information. The request unit can send requests using mass email or notification systems. For example, after matching the request content with the experts' skills, the selected experts are sent request emails simultaneously to prompt a prompt response. In addition, notification systems can be used to send real-time notifications to the experts' smartphones or computers. The request unit also has a function to manage the progress of requests and track responses from experts. In this way, the request unit can efficiently send requests to experts and promote prompt responses.

The check unit allows the experts who received the requests from the request unit to perform checks. The check unit can perform checks using methods such as review, verification, and testing. Specifically, the check unit manages the process in which the expert confirms the request conditions, accepts the request, and performs the check. The expert reviews the output result of the generative AI in detail based on the request content and checks for the presence or absence of hallucination. In the review, literature and databases are referenced to verify whether the output of the generative AI is accurate. In verification, actual data and experiments are used to confirm whether the output of the generative AI matches reality. In testing, the output of the generative AI is reproduced to confirm whether similar results can be obtained. The check unit records the results of the checks performed by the experts and prepares reports to report to the requester. Furthermore, the check unit collects feedback from experts and can use it to improve the system. In this way, the check unit can perform accurate checks on the request content and provide highly reliable results to the requester.

The accumulation unit accumulates the results obtained by the check unit. The accumulation unit can, for example, store the results in a database or accumulate them in report format. Specifically, the accumulation unit centrally manages the results provided by the check unit so that they can be used for future reference and analysis. The database stores detailed information on each request, check results, expert feedback, etc. This enables trend analysis and pattern recognition based on past request data. Furthermore, the accumulation unit accumulates, in a search-extended generation database, those verification results by the checker that received high evaluations from the requester. In this way, the system can respond to future requests with higher accuracy based on highly evaluated past results. The accumulation unit also takes into account data security and privacy protection, and the stored data is encrypted and protected from unauthorized access. In this way, the accumulation unit can achieve highly reliable data management and improve the overall performance and reliability of the system.

The reception unit can allow the requester to specify a range of portions in the output result of a generative AI suspected of hallucination and submit a request for content verification. The reception unit, for example, allows the requester to specify a range of portions in the output result of a generative AI suspected of hallucination and submit a request for content verification. The reception unit can also allow the requester to specify a reward cap and deadline when submitting a request for content verification. In this way, the requester can specify a range of portions suspected of hallucination and submit a request for content verification. Portions suspected of hallucination may include, for example, information that differs from facts or incorrect inferences, but are not limited to these examples. Some or all of the above-described processing in the reception unit may be performed using AI or may be performed without using AI. For example, the reception unit can input requests from the requester into AI and have the AI perform the reception.

The analysis unit can analyze the request from the requester and identify the specialized field and required skill level necessary for the check. The analysis unit, for example, analyzes the request from the requester using methods such as text analysis, data mining, and statistical analysis. The analysis unit analyzes the request and identifies the specialized field and required skill level necessary for the check. In this way, the analysis unit can analyze the request from the requester and identify the specialized field and required skill level necessary for the check. The required specialized fields may include, for example, medicine, law, technology, etc., but are not limited to these examples. The required skill levels may include, for example, beginner, intermediate, advanced, etc., but are not limited to these examples. Some or all of the above-described processing in the analysis unit may be performed using AI or may be performed without using AI. For example, the analysis unit can input requests into AI and have the AI perform the analysis.

The request unit can send requests simultaneously to all experts matching the case. The request unit, for example, sends requests simultaneously to all experts matching the case. The request unit can send requests using mass email or notification systems. In this way, the request unit can send requests simultaneously to all experts matching the case. Methods for sending requests simultaneously may include, for example, mass email or notification systems, but are not limited to these examples. Some or all of the above-described processing in the request unit may be performed using AI or may be performed without using AI. For example, the request unit can input requests into AI and have the AI perform the requests to experts.

The check unit can allow the expert to confirm the request conditions and accept the request to perform the check. The check unit, for example, allows the expert to confirm the request conditions and accept the request to perform the check. The check unit can perform checks using methods such as review, verification, and testing. In this way, the expert can confirm the request conditions and accept the request to perform the check. The request conditions may include, for example, delivery date, quality standards, reward, etc., but are not limited to these examples. Some or all of the above-described processing in the check unit may be performed using AI or may be performed without using AI. For example, the check unit can input requests into AI and have the AI perform the checks.

The accumulation unit can accumulate, in a search-extended generation database, those verification results by the checker that received high evaluations from the requester. The accumulation unit, for example, accumulates, in a search-extended generation database, those verification results by the checker that received high evaluations from the requester. In this way, the accumulation unit can accumulate, in a search-extended generation database, those results that received high evaluations from the requester. Results that received high evaluations may include, for example, feedback from the requester or evaluation scores, but are not limited to these examples. Some or all of the above-described processing in the accumulation unit may be performed using AI or may be performed without using AI. For example, the accumulation unit can input check results into AI and have the AI perform the accumulation of results.

The reception unit can estimate the requester's emotion and adjust the priority of the request content based on the estimated emotion of the requester. For example, if the requester feels urgency, the reception unit adjusts the processing so that the request content is handled with the highest priority. If the requester is relaxed, the reception unit can also adjust the processing so that the request content is handled with normal priority. If the requester feels anxiety, the reception unit can also raise the priority to respond quickly. In this way, the reception unit can adjust the priority of the request content based on the requester's emotion. The requester's emotions may include, for example, urgency, relaxation, anxiety, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the reception unit may be performed using AI or may be performed without using AI. For example, the reception unit can input the requester's emotion data into AI and have the AI perform the emotion estimation.

The reception unit can analyze the requester's past request history and select an optimal reception method. The reception unit, for example, preferentially proposes reception methods that the requester has frequently used in the past. The reception unit can also select the most efficient reception method based on the requester's past request history. The reception unit can also propose the optimal reception method for a specific time period based on the requester's past request history. In this way, the reception unit can analyze the requester's past request history and select an optimal reception method. The optimal reception methods may include, for example, online forms, telephone reception, etc., but are not limited to these examples. Some or all of the above-described processing in the reception unit may be performed using AI or may be performed without using AI. For example, the reception unit can input the requester's past request history into AI and have the AI select the optimal reception method.

The reception unit can perform filtering based on the requester's current projects and areas of interest at the time of receiving the request content. The reception unit, for example, preferentially receives request content related to the requester's ongoing projects. The reception unit can also filter highly relevant request content based on the requester's areas of interest. The reception unit can also propose optimal request content according to the progress of the requester's current projects. In this way, the reception unit can perform filtering based on the requester's current projects and areas of interest. The current projects and areas of interest may include, for example, project management tools, survey results, etc., but are not limited to these examples. Some or all of the above-described processing in the reception unit may be performed using AI or may be performed without using AI. For example, the reception unit can input data on the requester's current projects and areas of interest into AI and have the AI perform the filtering.

The reception unit can estimate the requester's emotion and determine the priority of requests to be received based on the estimated emotion of the requester. For example, if the requester feels stress, the reception unit processes the request content with the highest priority. If the requester is relaxed, the reception unit can also process the request content with normal priority. If the requester is in a hurry, the reception unit can also raise the priority to respond quickly. In this way, the reception unit can determine the priority of requests to be received based on the requester's emotion. The priority of requests may include, for example, urgency, importance, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the reception unit may be performed using AI or may be performed without using AI. For example, the reception unit can input the requester's emotion data into AI and have the AI perform the emotion estimation.

The reception unit can prioritize the reception of highly relevant requests by considering the requester's geographic location at the time of receiving the request content. The reception unit, for example, preferentially receives request content related to a specific region when the requester is in that region. The reception unit can also propose optimal request content based on the requester's current location. The reception unit can also filter highly relevant request content based on the requester's geographic location information. In this way, the reception unit can prioritize the reception of highly relevant requests by considering the requester's geographic location. Geographic location information may include, for example, GPS data, address information, etc., but are not limited to these examples. Some or all of the above-described processing in the reception unit may be performed using AI or may be performed without using AI. For example, the reception unit can input the requester's geographic location information into AI and have the AI perform the filtering.

The reception unit can analyze the requester's social media activity at the time of receiving the request content and receive related requests. The reception unit, for example, preferentially receives request content related to areas of interest based on the requester's social media activity. The reception unit can also propose optimal request content based on the requester's social media activity. The reception unit can also analyze the requester's social media activity and filter highly relevant request content. In this way, the reception unit can analyze the requester's social media activity and receive related requests. Social media activity may include, for example, post content, number of followers, etc., but are not limited to these examples. Some or all of the above-described processing in the reception unit may be performed using AI or may be performed without using AI. For example, the reception unit can input the requester's social media activity data into AI and have the AI perform the analysis.

The analysis unit can estimate the requester's emotion and adjust the method of expression of the analysis based on the estimated emotion of the requester. For example, if the requester is nervous, the analysis unit provides a simple and highly visible method of expression. If the requester is relaxed, the analysis unit can also provide a method of expression that includes detailed information. If the requester is in a hurry, the analysis unit can also provide a method of expression that focuses on the main points. In this way, the analysis unit can adjust the method of expression of the analysis based on the requester's emotion. The methods of expression of the analysis may include, for example, graphical display, text reports, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the analysis unit may be performed using AI or may be performed without using AI. For example, the analysis unit can input the requester's emotion data into AI and have the AI perform the emotion estimation.

The analysis unit can adjust the level of detail of the analysis based on the importance of the request content during analysis. The analysis unit, for example, performs detailed analysis for highly important request content. The analysis unit can also perform simplified analysis for less important request content. The analysis unit can also dynamically adjust the level of detail of the analysis according to the importance of the request content. In this way, the analysis unit can adjust the level of detail of the analysis based on the importance of the request content. The importance of the request content may include, for example, business impact, urgency, etc., but are not limited to these examples. Some or all of the above-described processing in the analysis unit may be performed using AI or may be performed without using AI. For example, the analysis unit can input importance data of the request content into AI and have the AI adjust the level of detail of the analysis.

The analysis unit can apply different analysis algorithms according to the category of the request content during analysis. The analysis unit, for example, applies specialized analysis algorithms to technical request content. The analysis unit can also apply creative analysis algorithms to creative request content. The analysis unit can also select the optimal analysis algorithm according to the category of the request content. In this way, the analysis unit can apply different analysis algorithms according to the category of the request content. The categories of the request content may include, for example, technology, marketing, legal affairs, etc., but are not limited to these examples. Some or all of the above-described processing in the analysis unit may be performed using AI or may be performed without using AI. For example, the analysis unit can input category data of the request content into AI and have the AI apply the analysis algorithm.

The analysis unit can estimate the requester's emotion and adjust the length of the analysis based on the estimated emotion of the requester. For example, if the requester is in a hurry, the analysis unit provides a short and concise analysis. If the requester is relaxed, the analysis unit can also provide a longer analysis with detailed explanations. If the requester is excited, the analysis unit can also provide an analysis with visually stimulating effects. In this way, the analysis unit can adjust the length of the analysis based on the requester's emotion. The length of the analysis may include, for example, number of pages, time, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the analysis unit may be performed using AI or may be performed without using AI. For example, the analysis unit can input the requester's emotion data into AI and have the AI perform the emotion estimation.

The analysis unit can determine the priority of analysis based on the submission timing of the request content during analysis. The analysis unit, for example, gives top priority to urgent request content. The analysis unit can also prioritize analysis for request content with a near deadline. The analysis unit can also dynamically adjust the priority of analysis according to the submission timing of the request content. In this way, the analysis unit can determine the priority of analysis based on the submission timing of the request content. The submission timing of the request content may include, for example, submission date, deadline, etc., but are not limited to these examples. Some or all of the above-described processing in the analysis unit may be performed using AI or may be performed without using AI. For example, the analysis unit can input submission timing data of the request content into AI and have the AI determine the priority.

The analysis unit can adjust the order of analysis based on the relevance of the request content during analysis. The analysis unit, for example, gives priority to analysis when the request content is related to other request content. The analysis unit can also determine the optimal analysis order based on the relevance of the request content. The analysis unit can also dynamically adjust the order of analysis by considering the relevance of the request content. In this way, the analysis unit can adjust the order of analysis based on the relevance of the request content. The relevance of the request content may include, for example, degree of theme match, past relevance, etc., but are not limited to these examples. Some or all of the above-described processing in the analysis unit may be performed using AI or may be performed without using AI. For example, the analysis unit can input relevance data of the request content into AI and have the AI adjust the order.

The request unit can estimate the requester's emotion and adjust the method of expression of the request based on the estimated emotion of the requester. For example, if the requester is nervous, the request unit provides a simple and highly visible method of expression. If the requester is relaxed, the request unit can also provide a method of expression that includes detailed information. If the requester is in a hurry, the request unit can also provide a method of expression that focuses on the main points. In this way, the request unit can adjust the method of expression of the request based on the requester's emotion. The methods of expression of the request may include, for example, formal style, casual style, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the request unit may be performed using AI or may be performed without using AI. For example, the request unit can input the requester's emotion data into AI and have the AI perform the emotion estimation.

The request unit can adjust the level of detail of the request based on the importance of the expert at the time of requesting. The request unit, for example, provides detailed request content to highly important experts. The request unit can also provide simplified request content to less important experts. The request unit can also dynamically adjust the level of detail of the request according to the importance of the expert. In this way, the request unit can adjust the level of detail of the request based on the importance of the expert. The importance of the expert may include, for example, years of experience, past achievements, etc., but are not limited to these examples. Some or all of the above-described processing in the request unit may be performed using AI or may be performed without using AI. For example, the request unit can input importance data of the expert into AI and have the AI adjust the level of detail.

The request unit can apply different request algorithms according to the category of the expert at the time of requesting. The request unit, for example, applies specialized request algorithms to technical experts. The request unit can also apply creative request algorithms to creative experts. The request unit can also select the optimal request algorithm according to the category of the expert. In this way, the request unit can apply different request algorithms according to the category of the expert. The categories of the expert may include, for example, medicine, law, technology, etc., but are not limited to these examples. Some or all of the above-described processing in the request unit may be performed using AI or may be performed without using AI. For example, the request unit can input category data of the expert into AI and have the AI apply the request algorithm.

The request unit can estimate the requester's emotion and adjust the length of the request based on the estimated emotion of the requester. For example, if the requester is in a hurry, the request unit provides a short and concise request. If the requester is relaxed, the request unit can also provide a longer request with detailed explanations. If the requester is excited, the request unit can also provide a request with visually stimulating effects. In this way, the request unit can adjust the length of the request based on the requester's emotion. The length of the request may include, for example, number of pages, time, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the request unit may be performed using AI or may be performed without using AI. For example, the request unit can input the requester's emotion data into AI and have the AI perform the emotion estimation.

The request unit can determine the priority of the request based on the submission timing of the expert at the time of requesting. The request unit, for example, gives top priority to urgent request content. The request unit can also prioritize requests for request content with a near deadline. The request unit can also dynamically adjust the priority of the request according to the submission timing of the expert. In this way, the request unit can determine the priority of the request based on the submission timing of the expert. The submission timing of the expert may include, for example, submission date, deadline, etc., but are not limited to these examples. Some or all of the above-described processing in the request unit may be performed using AI or may be performed without using AI. For example, the request unit can input submission timing data of the expert into AI and have the AI determine the priority.

The request unit can adjust the order of the request based on the relevance of the expert at the time of requesting. The request unit, for example, gives priority to requests when the expert is related to other request content. The request unit can also determine the optimal request order based on the relevance of the expert. The request unit can also dynamically adjust the order of the request by considering the relevance of the expert. In this way, the request unit can adjust the order of the request based on the relevance of the expert. The relevance of the expert may include, for example, degree of theme match, past relevance, etc., but are not limited to these examples. Some or all of the above-described processing in the request unit may be performed using AI or may be performed without using AI. For example, the request unit can input relevance data of the expert into AI and have the AI adjust the order.

The check unit can estimate the requester's emotion and adjust the method of checking based on the estimated emotion of the requester. For example, if the requester is nervous, the check unit provides a simple and highly visible checking method. If the requester is relaxed, the check unit can also provide a checking method that includes detailed information. If the requester is in a hurry, the check unit can also provide a checking method that focuses on the main points. In this way, the check unit can adjust the method of checking based on the requester's emotion. The methods of checking may include, for example, review, verification, testing, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the check unit may be performed using AI or may be performed without using AI. For example, the check unit can input the requester's emotion data into AI and have the AI perform the emotion estimation.

The check unit can analyze the past history of the request content at the time of checking and select the optimal checking method. The check unit, for example, selects the most efficient checking method based on the past history of the request content. The check unit can also propose the optimal checking method for a specific time period based on the past history of the request content. The check unit can also dynamically adjust the optimal checking method by analyzing the past history of the request content. In this way, the check unit can analyze the past history of the request content and select the optimal checking method. The optimal checking methods may include, for example, past history analysis, algorithm selection, etc., but are not limited to these examples. Some or all of the above-described processing in the check unit may be performed using AI or may be performed without using AI. For example, the check unit can input past history data of the request content into AI and have the AI select the checking method.

The check unit can customize the means of checking based on the current status of the request content at the time of checking. The check unit, for example, selects the optimal checking means according to the current status of the request content. The check unit can also propose specific checking means based on the current status of the request content. The check unit can also dynamically customize the checking means by considering the current status of the request content. In this way, the check unit can customize the means of checking based on the current status of the request content. The current status of the request content may include, for example, progress status, resource status, etc., but are not limited to these examples. Some or all of the above-described processing in the check unit may be performed using AI or may be performed without using AI. For example, the check unit can input current status data of the request content into AI and have the AI customize the means.

The check unit can estimate the requester's emotion and determine the priority of checking based on the estimated emotion of the requester. For example, if the requester feels stress, the check unit processes the checking content with the highest priority. If the requester is relaxed, the check unit can also process the checking content with normal priority. If the requester is in a hurry, the check unit can also raise the priority to respond quickly. In this way, the check unit can determine the priority of checking based on the requester's emotion. The priority of checking may include, for example, urgency, importance, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the check unit may be performed using AI or may be performed without using AI. For example, the check unit can input the requester's emotion data into AI and have the AI perform the emotion estimation.

The check unit can select the optimal checking method by considering the geographic location information of the request content at the time of checking. The check unit, for example, preferentially processes checking content related to a specific region when the requester is in that region. The check unit can also propose the optimal checking method based on the requester's current location. The check unit can also filter highly relevant checking content based on the requester's geographic location information. In this way, the check unit can select the optimal checking method by considering the geographic location information of the request content. Geographic location information may include, for example, GPS data, address information, etc., but are not limited to these examples. Some or all of the above-described processing in the check unit may be performed using AI or may be performed without using AI. For example, the check unit can input geographic location information of the request content into AI and have the AI select the checking method.

The check unit can analyze the social media activity of the request content at the time of checking and propose means of checking. The check unit, for example, preferentially processes checking content related to areas of interest based on the requester's social media activity. The check unit can also propose the optimal checking means based on the requester's social media activity. The check unit can also analyze the requester's social media activity and filter highly relevant checking content. In this way, the check unit can analyze the social media activity of the request content and propose means of checking. Social media activity may include, for example, post content, number of followers, etc., but are not limited to these examples. Some or all of the above-described processing in the check unit may be performed using AI or may be performed without using AI. For example, the check unit can input social media activity data of the request content into AI and have the AI propose the means.

The accumulation unit can estimate the requester's emotion and select accumulation data based on the estimated emotion of the requester. For example, if the requester is nervous, the accumulation unit preferentially accumulates important data. If the requester is relaxed, the accumulation unit can also accumulate normal data. If the requester is in a hurry, the accumulation unit can also preferentially accumulate important data to respond quickly. In this way, the accumulation unit can select accumulation data based on the requester's emotion. The selection of accumulation data may include, for example, importance of data, relevance, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the accumulation unit may be performed using AI or may be performed without using AI. For example, the accumulation unit can input the requester's emotion data into AI and have the AI perform the emotion estimation.

The accumulation unit can optimize the accumulation algorithm by referring to past accumulation data at the time of accumulation. The accumulation unit, for example, selects the optimal accumulation algorithm based on past accumulation data. The accumulation unit can also propose the optimal accumulation algorithm for a specific time period by referring to past accumulation data. The accumulation unit can also dynamically adjust the optimal accumulation algorithm by analyzing past accumulation data. In this way, the accumulation unit can optimize the accumulation algorithm by referring to past accumulation data. Accumulation algorithms may include, for example, reference to past data, adjustment of algorithms, etc., but are not limited to these examples. Some or all of the above-described processing in the accumulation unit may be performed using AI or may be performed without using AI. For example, the accumulation unit can input past accumulation data into AI and have the AI optimize the algorithm.

The accumulation unit can select accumulation data based on the current status of the request content at the time of accumulation. The accumulation unit, for example, selects the optimal accumulation data according to the current status of the request content. The accumulation unit can also propose specific accumulation data based on the current status of the request content. The accumulation unit can also dynamically select accumulation data by considering the current status of the request content. In this way, the accumulation unit can select accumulation data based on the current status of the request content. The current status of the request content may include, for example, progress status, resource status, etc., but are not limited to these examples. Some or all of the above-described processing in the accumulation unit may be performed using AI or may be performed without using AI. For example, the accumulation unit can input current status data of the request content into AI and have the AI select the data.

The accumulation unit can estimate the requester's emotion and adjust the frequency of accumulation based on the estimated emotion of the requester. For example, if the requester is nervous, the accumulation unit accumulates data frequently. If the requester is relaxed, the accumulation unit can also accumulate data at a normal frequency. If the requester is in a hurry, the accumulation unit can also accumulate data frequently to respond quickly. In this way, the accumulation unit can adjust the frequency of accumulation based on the requester's emotion. The frequency of accumulation may include, for example, periodic accumulation, event-driven accumulation, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the accumulation unit may be performed using AI or may be performed without using AI. For example, the accumulation unit can input the requester's emotion data into AI and have the AI perform the emotion estimation.

The accumulation unit can weight the accumulation data based on the submission timing of the request content at the time of accumulation. The accumulation unit, for example, accumulates with higher weighting for request content with a near deadline. The accumulation unit can also accumulate with normal weighting for request content with a distant deadline. The accumulation unit can also dynamically adjust the weighting of accumulation data according to the submission timing of the request content. In this way, the accumulation unit can weight the accumulation data based on the submission timing of the request content. The submission timing may include, for example, submission date, deadline, etc., but are not limited to these examples. Some or all of the above-described processing in the accumulation unit may be performed using AI or may be performed without using AI. For example, the accumulation unit can input submission timing data of the request content into AI and have the AI perform the weighting.

The accumulation unit can select accumulation data based on the relevance of the request content at the time of accumulation. The accumulation unit, for example, preferentially accumulates when the request content is related to other request content. The accumulation unit can also select the optimal accumulation data based on the relevance of the request content. The accumulation unit can also dynamically select accumulation data by considering the relevance of the request content. In this way, the accumulation unit can select accumulation data based on the relevance of the request content. The relevance of the request content may include, for example, degree of theme match, past relevance, etc., but are not limited to these examples. Some or all of the above-described processing in the accumulation unit may be performed using AI or may be performed without using AI. For example, the accumulation unit can input relevance data of the request content into AI and have the AI select the data.

The accumulation unit can select accumulation data based on the importance of the request content at the time of accumulation. The accumulation unit, for example, preferentially accumulates for highly important request content. The accumulation unit can also perform normal accumulation for less important request content. The accumulation unit can also dynamically adjust the selection of accumulation data according to the importance of the request content. In this way, the accumulation unit can select accumulation data based on the importance of the request content. The importance of the request content may include, for example, business impact, urgency, etc., but are not limited to these examples. Some or all of the above-described processing in the accumulation unit may be performed using AI or may be performed without using AI. For example, the accumulation unit can input importance data of the request content into AI and have the AI select the data.

The system according to the embodiment is not limited to the above-described examples and, for example, various modifications are possible as described below.

The reception unit can estimate the requester's emotion and adjust the priority of the request content based on the estimated emotion of the requester. For example, if the requester feels urgency, the reception unit adjusts the processing so that the request content is handled with the highest priority. If the requester is relaxed, the reception unit can also adjust the processing so that the request content is handled with normal priority. If the requester feels anxiety, the reception unit can also raise the priority to respond quickly. In this way, the reception unit can adjust the priority of the request content based on the requester's emotion. The requester's emotions may include, for example, urgency, relaxation, anxiety, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the reception unit may be performed using AI or may be performed without using AI. For example, the reception unit can input the requester's emotion data into AI and have the AI perform the emotion estimation.

The reception unit can analyze the requester's past request history and select an optimal reception method. For example, the reception unit preferentially proposes reception methods that the requester has frequently used in the past. The most efficient reception method can also be selected based on the requester's past request history. The optimal reception method for a specific time period can also be proposed based on the requester's past request history. In this way, the reception unit can analyze the requester's past request history and select an optimal reception method. The optimal reception methods may include, for example, online forms, telephone reception, etc., but are not limited to these examples. Some or all of the above-described processing in the reception unit may be performed using AI or may be performed without using AI. For example, the reception unit can input the requester's past request history into AI and have the AI select the optimal reception method.

The analysis unit can estimate the requester's emotion and adjust the method of expression of the analysis based on the estimated emotion of the requester. For example, if the requester is nervous, the analysis unit provides a simple and highly visible method of expression. If the requester is relaxed, the analysis unit can also provide a method of expression that includes detailed information. If the requester is in a hurry, the analysis unit can also provide a method of expression that focuses on the main points. In this way, the analysis unit can adjust the method of expression of the analysis based on the requester's emotion. The methods of expression of the analysis may include, for example, graphical display, text reports, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the analysis unit may be performed using AI or may be performed without using AI. For example, the analysis unit can input the requester's emotion data into AI and have the AI perform the emotion estimation.

The request unit can adjust the level of detail of the request based on the importance of the expert at the time of requesting. For example, the request unit provides detailed request content to highly important experts. The request unit can also provide simplified request content to less important experts. The request unit can also dynamically adjust the level of detail of the request according to the importance of the expert. In this way, the request unit can adjust the level of detail of the request based on the importance of the expert. The importance of the expert may include, for example, years of experience, past achievements, etc., but are not limited to these examples. Some or all of the above-described processing in the request unit may be performed using AI or may be performed without using AI. For example, the request unit can input importance data of the expert into AI and have the AI adjust the level of detail.

The check unit can estimate the requester's emotion and adjust the method of checking based on the estimated emotion of the requester. For example, if the requester is nervous, the check unit provides a simple and highly visible checking method. If the requester is relaxed, the check unit can also provide a checking method that includes detailed information. If the requester is in a hurry, the check unit can also provide a checking method that focuses on the main points. In this way, the check unit can adjust the method of checking based on the requester's emotion. The methods of checking may include, for example, review, verification, testing, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the check unit may be performed using AI or may be performed without using AI. For example, the check unit can input the requester's emotion data into AI and have the AI perform the emotion estimation.

The check unit can analyze the past history of the request content at the time of checking and select the optimal checking method. For example, the check unit selects the most efficient checking method based on the past history of the request content. The optimal checking method for a specific time period can also be proposed based on the past history of the request content. The check unit can also dynamically adjust the optimal checking method by analyzing the past history of the request content. In this way, the check unit can analyze the past history of the request content and select the optimal checking method. The optimal checking methods may include, for example, past history analysis, algorithm selection, etc., but are not limited to these examples. Some or all of the above-described processing in the check unit may be performed using AI or may be performed without using AI. For example, the check unit can input past history data of the request content into AI and have the AI select the checking method.

The accumulation unit can estimate the requester's emotion and select accumulation data based on the estimated emotion of the requester. For example, if the requester is nervous, the accumulation unit preferentially accumulates important data. If the requester is relaxed, the accumulation unit can also accumulate normal data. If the requester is in a hurry, the accumulation unit can also preferentially accumulate important data to respond quickly. In this way, the accumulation unit can select accumulation data based on the requester's emotion. The selection of accumulation data may include, for example, importance of data, relevance, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the accumulation unit may be performed using AI or may be performed without using AI. For example, the accumulation unit can input the requester's emotion data into AI and have the AI perform the emotion estimation.

The accumulation unit can optimize the accumulation algorithm by referring to past accumulation data at the time of accumulation. For example, the accumulation unit selects the optimal accumulation algorithm based on past accumulation data. The optimal accumulation algorithm for a specific time period can also be proposed by referring to past accumulation data. The accumulation unit can also dynamically adjust the optimal accumulation algorithm by analyzing past accumulation data. In this way, the accumulation unit can optimize the accumulation algorithm by referring to past accumulation data. Accumulation algorithms may include, for example, reference to past data, adjustment of algorithms, etc., but are not limited to these examples. Some or all of the above-described processing in the accumulation unit may be performed using AI or may be performed without using AI. For example, the accumulation unit can input past accumulation data into AI and have the AI optimize the algorithm.

The accumulation unit can estimate the requester's emotion and adjust the frequency of accumulation based on the estimated emotion of the requester. For example, if the requester is nervous, the accumulation unit accumulates data frequently. If the requester is relaxed, the accumulation unit can also accumulate data at a normal frequency. If the requester is in a hurry, the accumulation unit can also accumulate data frequently to respond quickly. In this way, the accumulation unit can adjust the frequency of accumulation based on the requester's emotion. The frequency of accumulation may include, for example, periodic accumulation, event-driven accumulation, etc., but are not limited to these examples. Emotion estimation is realized using, for example, an emotion engine or a generative AI with an emotion estimation function. The generative AI may be a text generative AI (e.g., LLM) or a multimodal generative AI, but is not limited to these examples. Some or all of the above-described processing in the accumulation unit may be performed using AI or may be performed without using AI. For example, the accumulation unit can input the requester's emotion data into AI and have the AI perform the emotion estimation.

The accumulation unit can weight the accumulation data based on the submission timing of the request content at the time of accumulation. For example, the accumulation unit accumulates with higher weighting for request content with a near deadline. The accumulation unit can also accumulate with normal weighting for request content with a distant deadline. The accumulation unit can also dynamically adjust the weighting of accumulation data according to the submission timing of the request content. In this way, the accumulation unit can weight the accumulation data based on the submission timing of the request content. The submission timing may include, for example, submission date, deadline, etc., but are not limited to these examples. Some or all of the above-described processing in the accumulation unit may be performed using AI or may be performed without using AI. For example, the accumulation unit can input submission timing data of the request content into AI and have the AI perform the weighting.

The following is a brief description of the processing flow of Example 2 of the Embodiment.

Step 1: The reception unit receives requests from a requester. The requests from the requester may include document format, oral requests, emails, etc. For example, the requester can specify a range of portions in the output result of a generative AI suspected of hallucination and submit a request for content verification.

Step 2: The analysis unit analyzes the requests received by the reception unit. The analysis unit analyzes the requests using methods such as text analysis, data mining, and statistical analysis, and identifies the specialized field and required skill level necessary for the check.

Step 3: The request unit sends requests to experts identified by the analysis unit. The request unit can send requests simultaneously to all experts matching the case and can use mass email or notification systems to send requests.

Step 4: The check unit allows the experts who received the requests from the request unit to perform checks. The check unit performs checks using methods such as review, verification, and testing, and allows the experts to confirm the request conditions and accept the request to perform the check.

Step 5: The accumulation unit accumulates the results obtained by the check unit. The accumulation unit stores the results in a database or accumulates them in report format, and accumulates, in a search-extended generation database, those verification results by the checker that received high evaluations from the requester.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described reception unit, analysis unit, request unit, check unit, and accumulation unit is realized by at least one of, for example, the smart device 14 and the data processing apparatus 12. For example, the reception unit is realized by the control unit 46A of the smart device 14 and receives requests from the requester. The analysis unit is realized, for example, by the specific processing unit 290 of the data processing apparatus 12 and analyzes the received requests. The request unit is realized, for example, by the specific processing unit 290 of the data processing apparatus 12 and sends requests to experts. The check unit is realized, for example, by the control unit 46A of the smart device 14 and allows experts to perform checks. The accumulation unit is realized, for example, by the specific processing unit 290 of the data processing apparatus 12 and accumulates check results. The correspondence between each unit and the device or control unit is not limited to the above examples and various modifications are possible.

### Second Embodiment

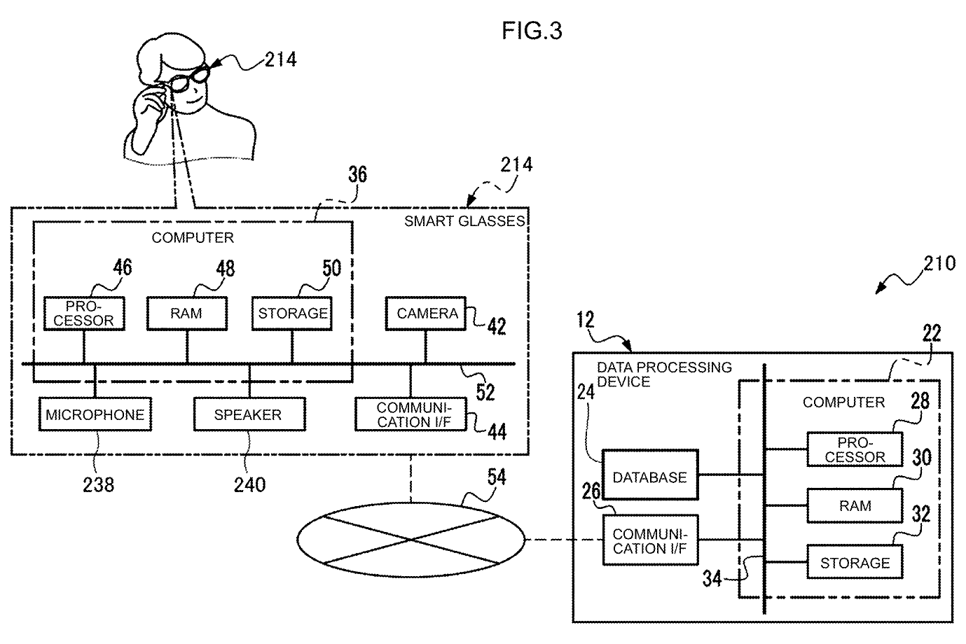

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

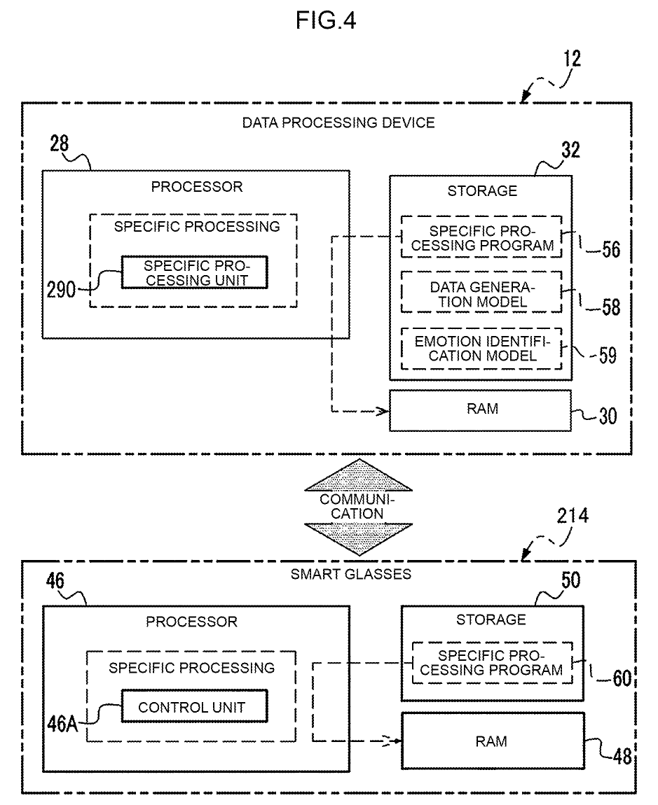

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described reception unit, analysis unit, request unit, check unit, and accumulation unit is realized by at least one of, for example, the smart glasses 214 and the data processing apparatus 12. For example, the reception unit is realized by the control unit 46A of the smart glasses 214 and receives requests from the requester. The analysis unit is realized, for example, by the specific processing unit 290 of the data processing apparatus 12 and analyzes the received requests. The request unit is realized, for example, by the specific processing unit 290 of the data processing apparatus 12 and sends requests to experts. The check unit is realized, for example, by the control unit 46A of the smart glasses 214 and allows experts to perform checks. The accumulation unit is realized, for example, by the specific processing unit 290 of the data processing apparatus 12 and accumulates check results. The correspondence between each unit and the device or control unit is not limited to the above examples and various modifications are possible.

### Third Embodiment

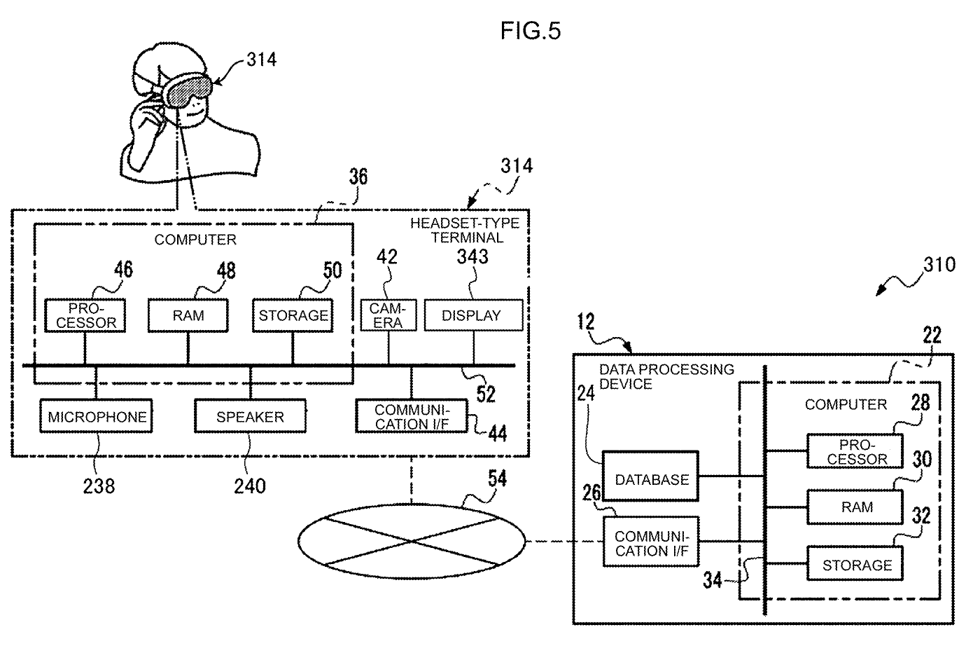

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

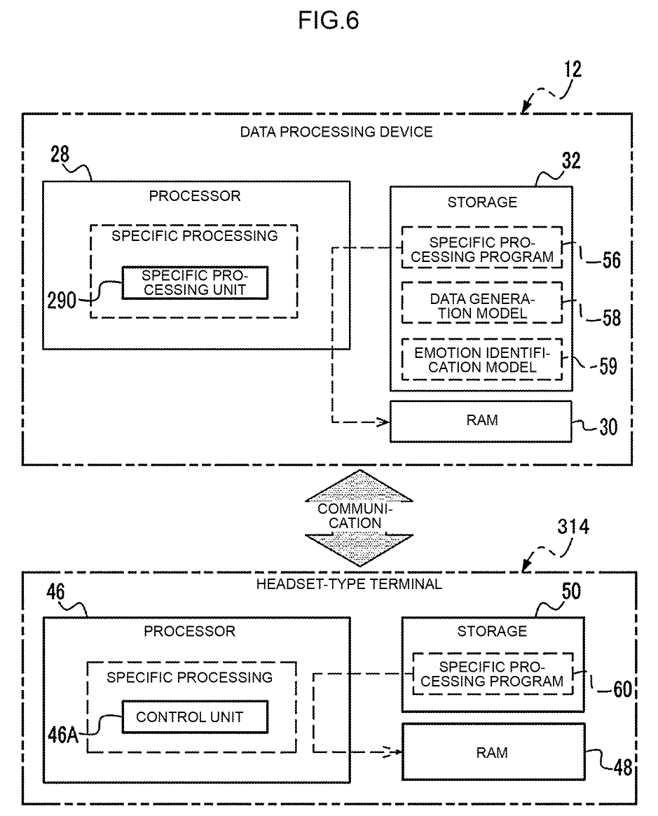

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described reception unit, analysis unit, request unit, check unit, and accumulation unit is realized by at least one of, for example, the headset-type terminal 314 and the data processing apparatus 12. For example, the reception unit is realized by the control unit 46A of the headset-type terminal 314 and receives requests from the requester. The analysis unit is realized, for example, by the specific processing unit 290 of the data processing apparatus 12 and analyzes the received requests. The request unit is realized, for example, by the specific processing unit 290 of the data processing apparatus 12 and sends requests to experts. The check unit is realized, for example, by the control unit 46A of the headset-type terminal 314 and allows experts to perform checks. The accumulation unit is realized, for example, by the specific processing unit 290 of the data processing apparatus 12 and accumulates check results. The correspondence between each unit and the device or control unit is not limited to the above examples and various modifications are possible.

### Fourth Embodiment

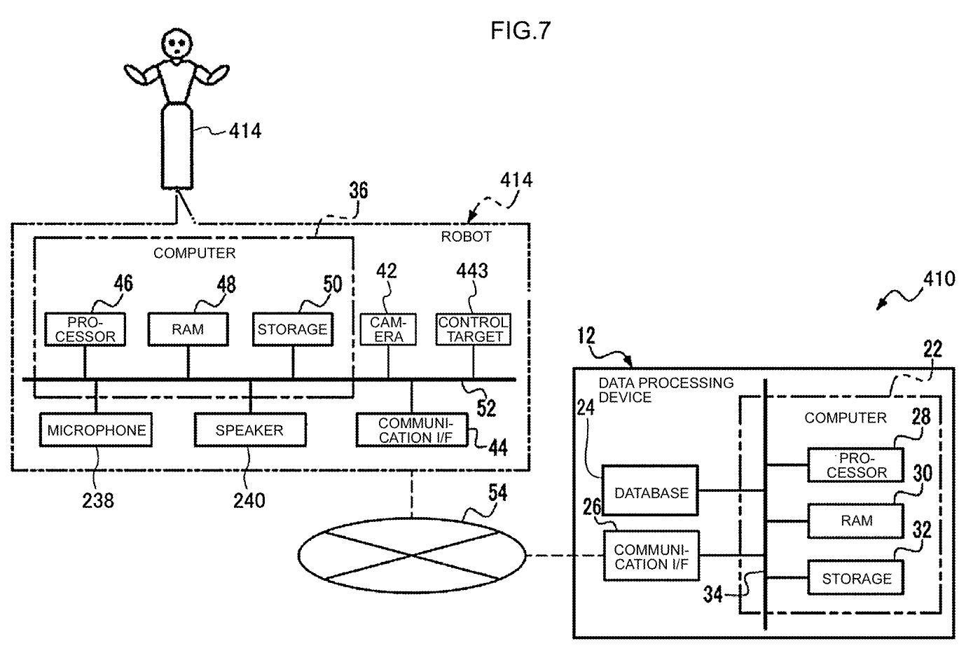

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

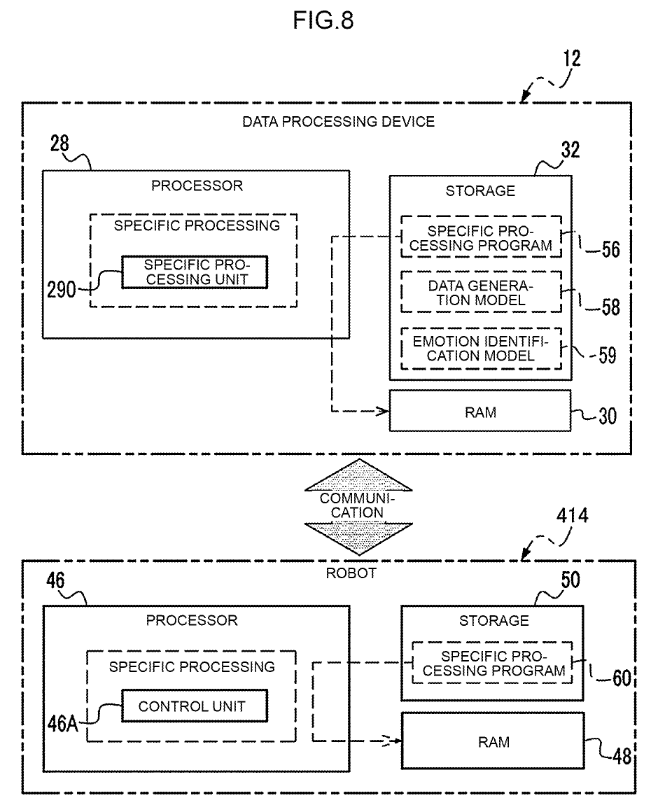

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described reception unit, analysis unit, request unit, check unit, and accumulation unit is realized by at least one of, for example, the robot 414 and the data processing apparatus 12. For example, the reception unit is realized by the control unit 46A of the robot 414 and receives requests from the requester. The analysis unit is realized, for example, by the specific processing unit 290 of the data processing apparatus 12 and analyzes the received requests. The request unit is realized, for example, by the specific processing unit 290 of the data processing apparatus 12 and sends requests to experts. The check unit is realized, for example, by the control unit 46A of the robot 414 and allows experts to perform checks. The accumulation unit is realized, for example, by the specific processing unit 290 of the data processing apparatus 12 and accumulates check results. The correspondence between each unit and the device or control unit is not limited to the above examples and various modifications are possible.

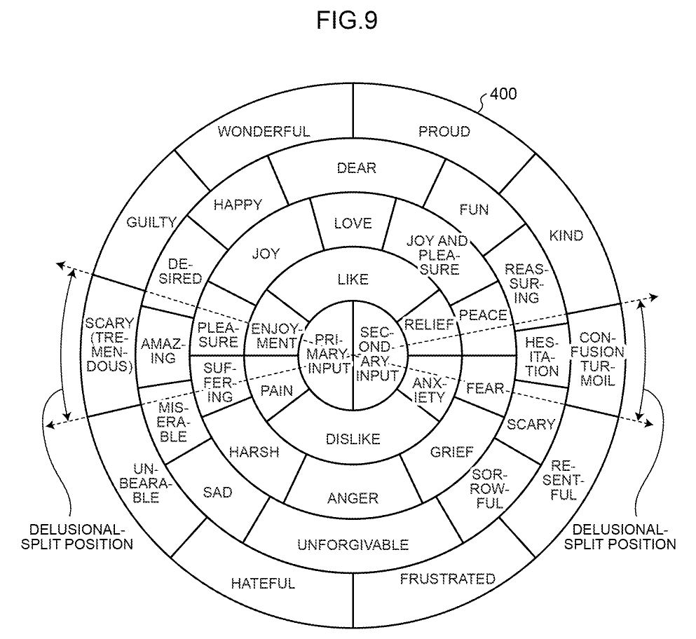

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, "pleasant" emotions are arranged, and on the lower side, "unpleasant" emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called "reactions," where sensations take precedence, are aligned. Additionally, in the right half of the emotion map, emotions belonging to the domain called "situations," where situational recognition takes precedence, are aligned.

In the emotion map, two emotions that promote learning are defined. One is a negative emotion around "repentance" or "reflection" on the situation side. In other words, when a negative emotion arises in the robot, like "I never want to feel this way again" or "I don't want to be scolded again." The other is an emotion around "desire" on the reaction side, which is positive. In other words, it is a positive feeling like "I want more" or "I want to know more."

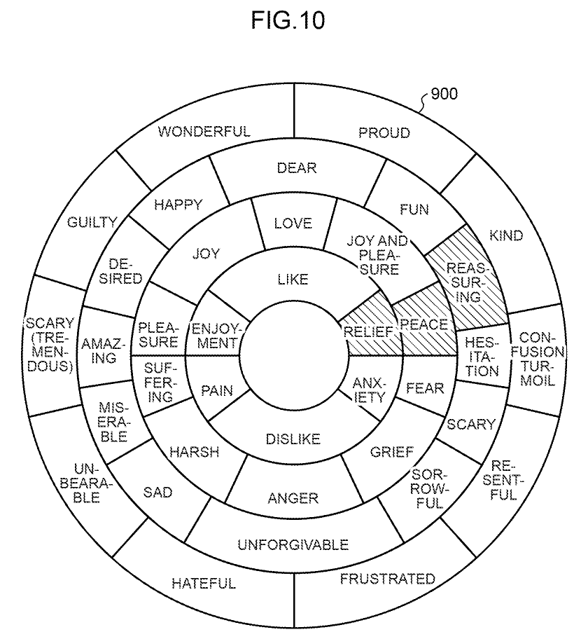

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like "reassured," "calm," and "confident" have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

[Additional Note 1] A system including: a reception unit configured to receive a request from a requester; an analysis unit configured to analyze the request received by the reception unit; a request unit configured to send a request to an expert identified by the analysis unit; a check unit configured to allow the expert who received the request from the request unit to perform a check; and an accumulation unit configured to accumulate the results obtained by the check unit.

[Additional Note 2] The system according to Additional Note 1, wherein the reception unit is configured to allow the requester to specify a range of portions in the output result of a generative AI suspected of hallucination and to submit a request for content verification.

[Additional Note 3] The system according to Additional Note 1, wherein the analysis unit is configured to analyze the request from the requester and identify the specialized field and required skill level necessary for the check.

[Additional Note 4] The system according to Additional Note 1, wherein the request unit is configured to send requests simultaneously to all experts matching the case.

[Additional Note 5] The system according to Additional Note 1, wherein the check unit is configured to allow the expert to confirm the request conditions and accept the request to perform the check.

[Additional Note 6] The system according to Additional Note 1, wherein the accumulation unit is configured to accumulate, in a search-extended generation database, those verification results by the checker that received high evaluations from the requester.

[Additional Note 7] The system according to Additional Note 1, wherein the reception unit is configured to estimate the requester's emotion and adjust the priority of the request content based on the estimated emotion of the requester.

[Additional Note 8] The system according to Additional Note 1, wherein the reception unit is configured to analyze the requester's past request history and select an optimal reception method.

[Additional Note 9] The system according to Additional Note 1, wherein the reception unit is configured to perform filtering based on the requester's current projects and areas of interest at the time of receiving the request content.

[Additional Note 10] The system according to Additional Note 1, wherein the reception unit is configured to estimate the requester's emotion and determine the priority of requests to be received based on the estimated emotion of the requester.

[Additional Note 11] The system according to Additional Note 1, wherein the reception unit is configured to prioritize the reception of highly relevant requests by considering the requester's geographic location at the time of receiving the request content.

[Additional Note 12] The system according to Additional Note 1, wherein the reception unit is configured to analyze the requester's social media activity at the time of receiving the request content and receive related requests.

[Additional Note 13] The system according to Additional Note 1, wherein the analysis unit is configured to estimate the requester's emotion and adjust the method of expression of the analysis based on the estimated emotion of the requester.

[Additional Note 14] The system according to Additional Note 1, wherein the analysis unit is configured to adjust the level of detail of the analysis based on the importance of the request content during analysis.

[Additional Note 15] The system according to Additional Note 1, wherein the analysis unit is configured to apply different analysis algorithms according to the category of the request content during analysis.

[Additional Note 16] The system according to Additional Note 1, wherein the analysis unit is configured to estimate the requester's emotion and adjust the length of the analysis based on the estimated emotion of the requester.

[Additional Note 17] The system according to Additional Note 1, wherein the analysis unit is configured to determine the priority of analysis based on the submission timing of the request content during analysis.

[Additional Note 18] The system according to Additional Note 1, wherein the analysis unit is configured to adjust the order of analysis based on the relevance of the request content during analysis.

[Additional Note 19] The system according to Additional Note 1, wherein the request unit is configured to estimate the requester's emotion and adjust the method of expression of the request based on the estimated emotion of the requester.

[Additional Note 20] The system according to Additional Note 1, wherein the request unit is configured to adjust the level of detail of the request based on the importance of the expert at the time of requesting.

[Additional Note 21] The system according to Additional Note 1, wherein the request unit is configured to apply different request algorithms according to the category of the expert at the time of requesting.

[Additional Note 22] The system according to Additional Note 1, wherein the request unit is configured to estimate the requester's emotion and adjust the length of the request based on the estimated emotion of the requester.

[Additional Note 23] The system according to Additional Note 1, wherein the request unit is configured to determine the priority of the request based on the submission timing of the expert at the time of requesting.

[Additional Note 24] The system according to Additional Note 1, wherein the request unit is configured to adjust the order of the request based on the relevance of the expert at the time of requesting.

[Additional Note 25] The system according to Additional Note 1, wherein the check unit is configured to estimate the requester's emotion and adjust the method of checking based on the estimated emotion of the requester.

[Additional Note 26] The system according to Additional Note 1, wherein the check unit is configured to analyze the past history of the request content at the time of checking and select the optimal checking method.

[Additional Note 27] The system according to Additional Note 1, wherein the check unit is configured to customize the means of checking based on the current status of the request content at the time of checking.

[Additional Note 28] The system according to Additional Note1, wherein the check unit is configured to estimate the requester's emotion and determine the priority of checking based on the estimated emotion of the requester.

[Additional Note 29] The system according to Additional Note 1, wherein the check unit is configured to select the optimal checking method by considering the geographic location information of the request content at the time of checking.

[Additional Note 30] The system according to Additional Note 1, wherein the check unit is configured to analyze the social media activity of the request content at the time of checking and propose means of checking.

[Additional Note 31] The system according to Additional Note 1, wherein the accumulation unit is configured to estimate the requester's emotion and select accumulation data based on the estimated emotion of the requester.

[Additional Note 32] The system according to Additional Note 1, wherein the accumulation unit is configured to optimize the accumulation algorithm by referring to past accumulation data at the time of accumulation.

[Additional Note 33] The system according to Additional Note 1, wherein the accumulation unit is configured to select accumulation data based on the current status of the request content at the time of accumulation.

[Additional Note 34] The system according to Additional Note 1, wherein the accumulation unit is configured to estimate the requester's emotion and adjust the frequency of accumulation based on the estimated emotion of the requester.

[Additional Note 35] The system according to Additional Note 1, wherein the accumulation unit is configured to weight the accumulation data based on the submission timing of the request content at the time of accumulation.

[Additional Note 36] The system according to Additional Note 1, wherein the accumulation unit is configured to select accumulation data based on the relevance of the request content at the time of accumulation.

[Additional Note 37] The system according to Additional Note 1, wherein the accumulation unit is configured to select accumulation data based on the importance of the request content at the time of accumulation.

What is claimed is:

1. A system comprising: a reception unit configured to receive a request from a requester; an analysis unit configured to analyze the request received by the reception unit; a request unit configured to send a request to an expert identified by the analysis unit; a check unit configured to allow the expert who received the request from the request unit to perform a check; and an accumulation unit configured to accumulate the results obtained by the check unit.

2. The system according to claim 1, wherein the reception unit is configured to allow the requester to specify a range of portions in the output result of a generative AI suspected of hallucination and to submit a request for content verification.

3. The system according to claim 1, wherein the analysis unit is configured to analyze the request from the requester and identify the specialized field and required skill level necessary for the check.

4. The system according to claim 1, wherein the request unit is configured to send requests simultaneously to all experts matching the case.

5. The system according to claim 1, wherein the check unit is configured to allow the expert to confirm the request conditions and accept the request to perform the check.

6. The system according to claim 1, wherein the accumulation unit is configured to accumulate, in a search-extended generation database, those verification results by the checker that received high evaluations from the requester.

7. The system according to claim 1, wherein the reception unit is configured to estimate the requester's emotion and adjust the priority of the request content based on the estimated emotion of the requester.

8. The system according to claim 1, wherein the reception unit is configured to analyze the requester's past request history and select an optimal reception method.

9. The system according to claim 1, wherein the reception unit is configured to perform filtering based on the requester's current projects and areas of interest at the time of receiving the request content.

10. The system according to claim 1, wherein the reception unit is configured to estimate the requester's emotion and determine the priority of requests to be received based on the estimated emotion of the requester.
